(19) United States
(12) Patent Application Publication
(10) Pub. No.: US 2012/0198762 A1
(43) Pub. Date: Aug. 9, 2012

(54) SPECTURAL SPECIFIC HORTICULTURE APPARATUS

(76) Inventor: RICKY LEE, San Diego, CA (US)

(21) Appl. No.: 13/020,809

(22) Filed: Feb. 4, 2011

(51) Int. Cl. A01G 9/14; A01G 1/00

(52) U.S. Cl. 47/17; 47/1.1 R

(57) ABSTRACT

A device would be desirable if it reflected directional light, and if it could stimulate the phenomena of horticulture efficiently in a place where sunlight may not be readily available. Then it could be possible to harvest desirable crops in any season. Given that the climate is right and plants are properly fed with both micro and primary nutrients; this device would propagate the best growth in green photosynthetic plants by simulating a band of magnetic frequencies that enhance the photoperiodism states. This device will use wavelengths approaching the UV and IR spectrum but will stay within the bounds of beneficial frequencies. Desired growth being: biomass gain, yield, and the metabolic integrity of the plant. The device ought to aid in biomass gain by achieving desirable light cycles, color band ratios and aid in air circulation in the vicinity of the plants (in turn affecting respiration and transpiration).

### BACKGROUND

Working our way into the 20^{th} century has never been more exciting. With all of the technologies that have been achieved the possibilities of innovations are limitless.

For years, I, along with countless others have sought a lamp that could effectively propagate plant growth. The past solution was to purchase the next largest filament bulb in the market. This can no longer be done economically with the rising cost of electricity and resources. Consumers' options had been limited to fluorescent and incandescent bulbs. Both bulbs have short operating lives and replacing parts are costly. With the innovations in LEDs (Light Emitting Diodes) a cost effective solution is in grasp.

Between College and lighting classes I gained a better understanding of the color frequencies and the magnetic spectrum. I took interest in the art of inverse light coloring and the effects experienced by photography. One example is how a magenta light is used to back—light someone in front of a green screen. Magenta cancels the reflected green from the screen, thus the colors become a shade.

In nature the summer light is rich in a blue tint achieved after the spring equinox (March 20). Giving plants a cycle of light sixteen-hours or more to feed. During this cycle the sun filters through less atmosphere making the ratio of blue greater than that of red (approximately 6700K˜5500K). Another key point is after the fall equinox (September 22), the days get shorter and the Suns' rays filter through more atmosphere, giving the light a red tint (approximately 5000K˜4100K). Most plants begin photoperiodism when given an approximate light cycle of 12 hr on/12 hr off.

The factors that contribute to the development of plants are proper: magnetic ratios, atmosphere, nutrients, water, and climate; then they will flourish.

The advantages of LED technologies opposed to incandescent lights are the bulbs life expectancies, lower heat signatures, and a pinpointed light spectrum. LEDs illuminate in nanoseconds when power is administered; HID's (High Intensity Discharge) lamps can take up to 30 minutes to reach its full spectrum and intensity. When a break in a plants light cycle arises, such as a power outage (plus a slow charging light) means the longer they will remain unlit and the likelihood the plant will enter a state of shock is greater, resulting in lower biomass/harvest/yield production also known as being in a stunned state.

The LED lamp has a longer life expectancy then HID bulbs. With the cost of the LED lamps and low wattage consumption, time and money are saved over time. 400 W and 1000 W HID bulbs require replacements every eight months to maintain their spectrum and require heavy ballasts. Opposed to High Flux LEDs that would hold their spectrum for their life expectancy (100 k hrs) with out the use of bulky ballast.

High pressure bulbs can produce undesirable frequencies that can be damaging to living cells; leading to burnt leaves if not filtered (infrared/UV-B). A study at the Laboratory of Plan Ecology, University of Antwerpen, concluded in 1997, UV-B clearly correlated to a reduction of photosynthesis and root-mass in rye. With LEDs, frequencies are not extreme because they have been pinpointed. These emitters do not need to operate at high temperatures to illuminate at their frequencies, allowing for the ease in climate control compared to HID lamps. HIDs can quickly heat a cultivation room. These lamps consume a greater amount of electricity to keep in operation let along the energy used to control that heat.

A switch activates the promotion of either the metabolic or floral photonic ratios. A lamp tailored to floral production, and another tailored to vegetative growth could spread the workload over a greater area. Most lamps on the market are single state; one ratio fits all, lamps with a much leaner or broad/ambiguous spectral span.

There was not a product on the market that had the characteristics I saw desirable in one unit, so I sought to revolutionize the market. To progress an apprentice tailored to horticulture could further allow consumers to produce their own crop demands.

Fans have been implemented to the design of the lamp to aid air circulation in the lamps proximity along with regulating core temperature. This is important because plants grow stronger stocks and healthier overall with air circulation and warmth: 20˜30 Celsius.

The selected nanometers of this devise range in blue (350-475 nm) and red (640-800 nm). This provides an array of usable energy, which can be harvested by the plant to achieve photosynthesis, pigmentation, and other metabolic processes. These wavelengths will cause the plant to develop nutritious biomass more effectively.

In a 10-watt investigation a stunned plant was brought out of its state of shock in a week; that day a cut was made from the plant and was placed in the soil next to the original plant. A month later, to my surprise both the plant and the cut were still healthy. The mother had developed new nods where as the cut started to develop its own biomass and remained lush, this with out the assistance of a moister tent nor rooting hormones. Pulling the cut, revealed a healed knob, with additional stimulation it could have rooted. In that instant, I was shown a glimmer of great potential.

Later referencing the patent office, the only product which had similarities was U.S. Pat. No. 6,921,182 B2. Their lamp focused heavily in the red (660 nm) spectrum. Such institutions as the Lighting Laboratory of Helsinki University of Technology, Institute of Materials Science and Applied Research of Vilnius University, and Lithuanian Institute of Horticulture state that: 9:1 red to blue single state lamp is sufficient (concluded in 2007). A trial of the 90% red to 10% blue had left specimens with stringy limbs with nods developing far apart. I noted that in nature, 9:1 red to blue is not achieved; there are more proportional balances between the blue and red frequencies. These studies had ruled out the importance of the other photo-activated syntheses and had under estimated the important role of short wave lengths to plants, such as deep blue and the UV-A.

This innovation is characterize by the following spans:
blue: (350-475 nm) and red: (630-800 nm). Field-testing supports violet (360 nm) photons can aid plants aroma, flowers, fruit, pigmentation, and research by these institutions suggests it aids in antioxidants production (phenolic compounds).

This device has the potential to save its host money in maintenance and electricity consumption, this is done by effectively pinpointing the beneficial wavelengths along with an affective means to convert electricity to useable photons.

### BRIEF SUMMARY

### Embodiment of the Invention

With the importance of each wavelength, several high-flux emitters have been selected to achieve the desired spectral spread. Each emitter has been taken into consideration for its magnetic frequency, brightness, and beam flux emitted.

This lamp may vary in size, shape, and intensity but will be comprised of ratios derived from the amount of 350 nm-475 nm photons being emitted.

The beam emitted by such emitters is desired within 140 degrees; this would dismiss the need for a reflective hood.

As needed, a lamps design may call for modification to shape or in intensity, thus the power supply must provide amps as needed. Note that what characterizes this lamp is not its shape but is innovation in pinpointed frequencies, their ratio, and the overall potential of the apparatus to stimulate plants.

Fans are in place to supplement the current air circulation. For every cc (cubic centimeter) of air forced in via fans or turbines, there will be a means of remove that cc, thus creating air circulation in the vicinity of the lamp. These fans also support the plant by aiding respiration and transpiration along with regulating the inner components temperature.

Power supplied to the High Flux LEDs may vary by region. Therefore the ratio and clustering of the diodes would have to match the provided power supply and voltage.

The ideal dimensions for the innovation would have a depth to contain the fans, heat sink, wiring, and other delicate components preferably within the trough. As to the width and length of the lamp; it will be configured to the applications at hand and must provide the necessary surface area for diode placement. A lamps emitted intensity will be the gauge of its size.

### BRIEF DESCRIPTION OF THE DRAWINGS

Some of the figures can be better understood through analysis of the description along with seeing the figure along sides:

LEGEND:
(P) Plant in root-medium
(0) Deep Amber 635˜655 nm
(1) Red 660˜670 nm
(2) Deep Red 720˜730 nm
(3) Violet 390˜420 nm
(4) Indigo 420˜435 nm
(5) Blue 450˜475 nm
(6) Intake port
(7) Exhaust port
(8) Distance (with in a half meter)
(9) The lamp
(10) Reflective walls/surface
(11) Reflected energy/Supplement lamp
(12) Lamps beams point of intersection
(13) Absorption of conmen green plants
(14) Diode emitted frequency
(15) Power supply, incremented by 12V
(16) The quantity of clusters in parallel
(17) The series of emitters
(18) Completing of the circuit
(19) Exhausted circulation
(20) Drawn in circulation
(21) Stage selecting switch
(22) Light cycle controlling timer
(23) Shell, electrical housing
(24) Heat-sink
(25) Rising warmth/respiration/oxygen
(26) Room intake
(27) Room exhaust
(28) Respiration

FIG. 1 (A) discloses the outer shell of the lamp (23), its exhaust port (7).

FIG. 1 (A) discloses the panel (21) used to achieve the lamps different states, where (22) is the timer. For sake of convenience, all of these amenities may all be on the same viewing panel.

FIG. 1 (B) discloses a configuration of emitters mounted on a heat sink (24) where the intake draws from (6). Heat sink and outer shell (23) inter lock leaving a sleek shell housing.

FIG. 2 (A) discloses how walls (10) can be used to reflect light (11), when plants exceed 5 feet supplement lamps can be placed in place of (11) to illuminate the mid and lower canopy effectively, thus allowing greater absorption and biomass production.

FIG. 2 (A) discloses the height of the lamp (9) to be within a half meter (8) from the potted plant (P).

FIG. 2 (B) discloses how two or more lamps, side-by-side could be used effectively to cross-light (12) a bouquet of plants.

FIG. 3 (A) displays the spectral spread achieved by the emitters' 350-475 nm and red 640-800 nm, (13) being the absorption level of green photosynthetic plants, and (14) being the frequencies achieved by the lamps' emitters.

FIG. 3 (B) discloses how the power supply (15) may be in increments of 12V (such as: . . . 12/2 v, 12 v, 24 v, 48 v, 120 v, 228 v, ect.) with the emitters configured a in sires (17) to complete the circuit (18).

FIG. 3 (B) also presents how the amount of clusters in parallel (16) is only limited by their power supplies capacity.

FIG. 4 (A) discloses the lamps' intake (20) and exhaust (19) along with the direction of the induction.

FIG. 4 (B) discloses how the lamp aids air circulation in a cultured room near the lamp. Room intake (26) could be a CO2 rich atmosphere; where as the rooms exhaust could flow into the main atmosphere system for it would have through plant respiration (28) and would be rich in oxygen (25).

### EMBODIMENTS OF THE INVENTION

With the importance of each frequency, sets of high-flux emitters have been selected to achieve the desired spectral spread. These magnetic frequencies are currently known to affect photosynthesis, chlorophyll development, along with other metabolic processes in green plants. Each emitter has been taken into consideration for its magnetic properties; photon and beam flux emitted (Lumen are disregarded, do to its measurement being based on the perception of light to the human eye; whereas we are dealing with plants). Wavelengths that would characterize this lamp: 365 nm, 420 nm, 430 nm, 460 nm, 470 nm, 635 nm, 648 nm, 662 nm, 730 nm, 770 nm 800 nm. Variations within the bounds of: 350-475 nm and 630-800 nm maybe substitutable.

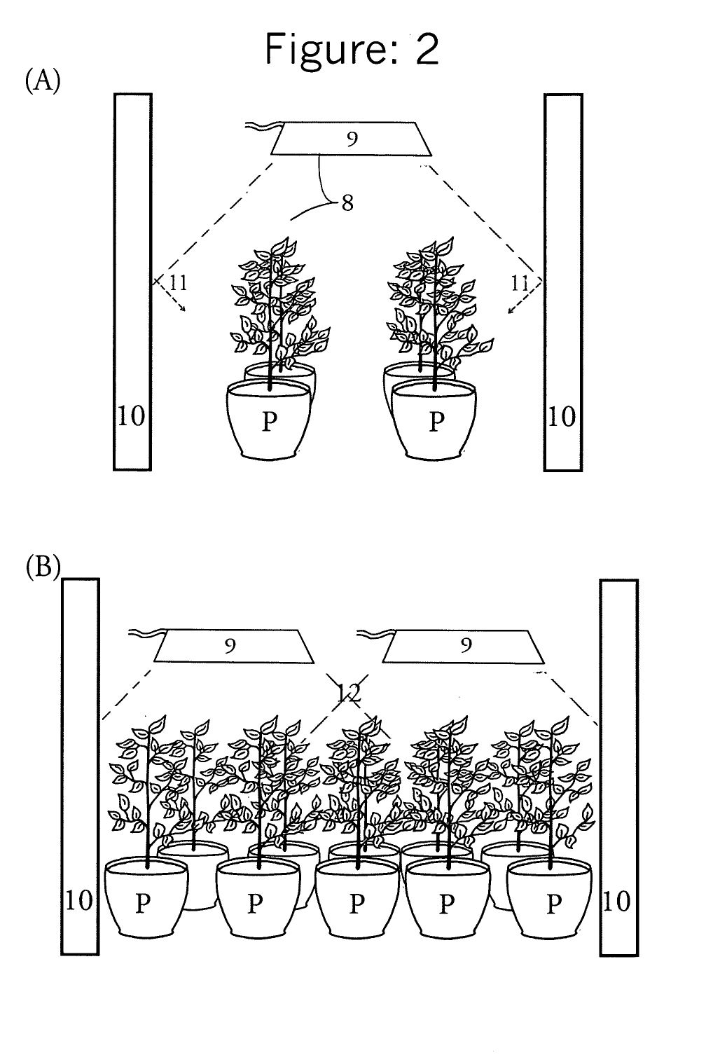

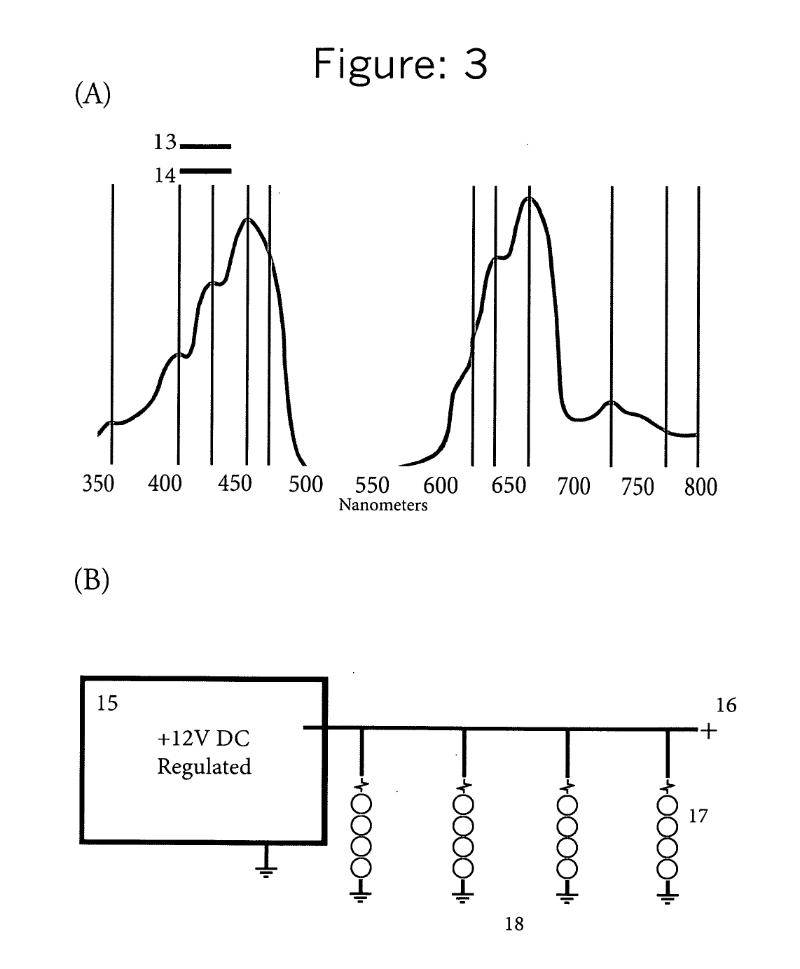

Photons can easily be reflected back to the plants in ways similarly done with current lighting techniques as in FIG. 2 A. Better exposing the upper, mid, and lower portions of the plant to usable photons that hastens growth. Plants can be plotted closely together under the lamp. Multiple lamps could be arranged side-by-side as in FIG. 2 B or staggered under the key lamp to further supplement a 5 foot or taller plant and optimizing lower branch production.

Each lamp may vary in size and shape but will be derived from ratios based on the quantity of blue photons being emitted and to the needs of the plants at hand.

For every 35 to 65 percent from the bounds of 350-475 nm there will be 65 to 35 percent from the bounds of 630-800 nm.

Successful ratio for floral propagation:

(0.11326) 365 nm˜410 nm˜430 nm

(0.33978) 455 nm˜465 nm

(0.19416) 648 nm˜655 nm

(0.32360) 660 nm˜662 nm˜665 nm

(0.02917) 730 nm˜770 nm˜800 nm

A ratio for metabolic propagation:

(0.04854) 365 nm˜410 nm˜j 430 nm

(0.51777) 455 nm˜465 nm

(0.14562) 648 nm˜655 nm

(0.25888) 660 nm˜662 nm˜665 nm

(0.02917) 730 nm˜770 nm˜800 nm

These ratios were calibrated for most green plants to experience better control of biomass/harvest/yield/production and could be tuned to achieve greater results. Specimens where kept as bonsais until flowering was induced. Lamps Field-tested to date are of a 65-watt, 225-watt, and a 550-watt consuming lamp whereas approximately 10% of their consumption was for induction of the transpired air. In these trials specimens developed, plants developed hardier trunks. Nods easily developed into tops with favorable nod spacing. Desired operating temperature of the heat sink 21˜30 degrees Celsius; emitter junction temperature maybe closer to 30˜43 Celsius. Thermal grease bridges the emitter to the heat sink further aiding the thermal-flux. An auto kill-switch attached to the aluminum heat sink will engage stopping the emitters given that the temperature where to double (60˜80 Celsius); when operating temperature is re-achieved electricity will be re-administer to the emitters.

The emitters' approximate beam-flux 120 degrees would dismiss the need for a reflector. The series of emitters ought to be protected by a non-static membrane as treated tempered glass.

When the switch is set to position one (metabolic), it will boost the ratio of blue light. Metabolic growth stimulates: healing, germination, new bud formation, stock swelling, cloning, and strong root development.

When set to position two (floral specific), it will boost the red color spectrum, aiding: flora density, aroma, pigment, elongating of nods, and biomass development.

Single stage lamps may also be configured; these lamps, thereby, will be used to support the lower portions of the plants or to supplement segregated grow spaces to further isolate the culture of specimens.

Intake and exhaust are in place to supplement the circulation and keep the air moving. For every cc of air forced in via fan or turbine, there will a means to removing that cc of air thus aiding in both cooling inner electrical components and stimulating plant respiration/transpiration.

Lamp systems would be powered in increments of 12 v. In the USA region, 120 v is commonly found and can be used to run the lamp via full spectrum bridge rectifier; thus the emitters would be series to handle the voltage. Means of steadying the current, energy density, and surge would have to be implemented before being fed to the emitters.

The ideal dimensions for the device would be to contain a timer, fans, resistors, aluminum heat sinks, thermal kill switch, and wiring within the trough of the lamp improving its sleek appearance and aiding to channel transpiration. This inner compartment would also house any other fragile or essential components. The timer would be used to control the light cycle to better simulate one of the two equinox stages (Photoperiodism).

When the lamp is set to its vegetative state, the ratio of red to blue will be approximately 4:6 in favor of blue. This state can be used to nurse sickly plants, promote erratic branch/leaf/nod formation, or even propagating scions. When in the floral state, the lamp will be approximately 6:4 in favor of red. An ideal use for this state will be to promote flowering, fruiting, seeding, and nod elongating.

365 nm, also categorized, as UV-A is not harmful to living cells. UV-A along with violet (413 nm) stimulates bacterium-chlorophyll, phenolic compounds, pigmentation, and carotene development. Violet light contributes to the plants pigmentation, which affect antioxidant production and the rising of leaves. 420 nm, indigo stimulates chlorophyll-A, vascular cambium, and bacterium-chlorophyll. 460 nm, blue affects chlorophyll-B, bacterium-chlorophyll, vascular cambium, and carotenoid production. Frequencies such as 350-475 nm do not cause much vertical growth but are critical for the metabolic health of the plant aiding in healing, translocation, vascular circulation, cell division/swelling/elongation/differentiation, roots development, budding, and the absorption of nutrients. The blue spectrum aids in the processing of the red spectral band.

800 nm, 770 nm, and 730 nm primarily aids in bacterium-chlorophyll, carotenoid production, and leaves rising. 662 nm, deep red aids in chlorophyll-A, bacterium-chlorophyll, distancing of nods, and carotenoid production. (648 nm) deep amber is the driving force for chlorophyll-B and aids in carotenoid production. These frequencies support the cells division/swelling/elongation/differentiation, cambium, translocation, vascular circulation, and the reproductive plant stage. This data was gathered from an accumulation of institutional biological papers, which were used as a guide. The trials and on going field test have shown to support these documents claims with tangible evidence in biomass production.

The primary blue frequency band ranges from 420 to 475 nm; Secondary band ranges from 365 to 420 nm. The Primary red frequency band ranges from 635 to 675 nm; Secondary band ranges from 710 to 800 nm. Photons emitted by this lamp will be derived from ratios that reflect these characters and the importance of spectral ratios during vegetative growth along with the ratios during the plants reproductive stage.

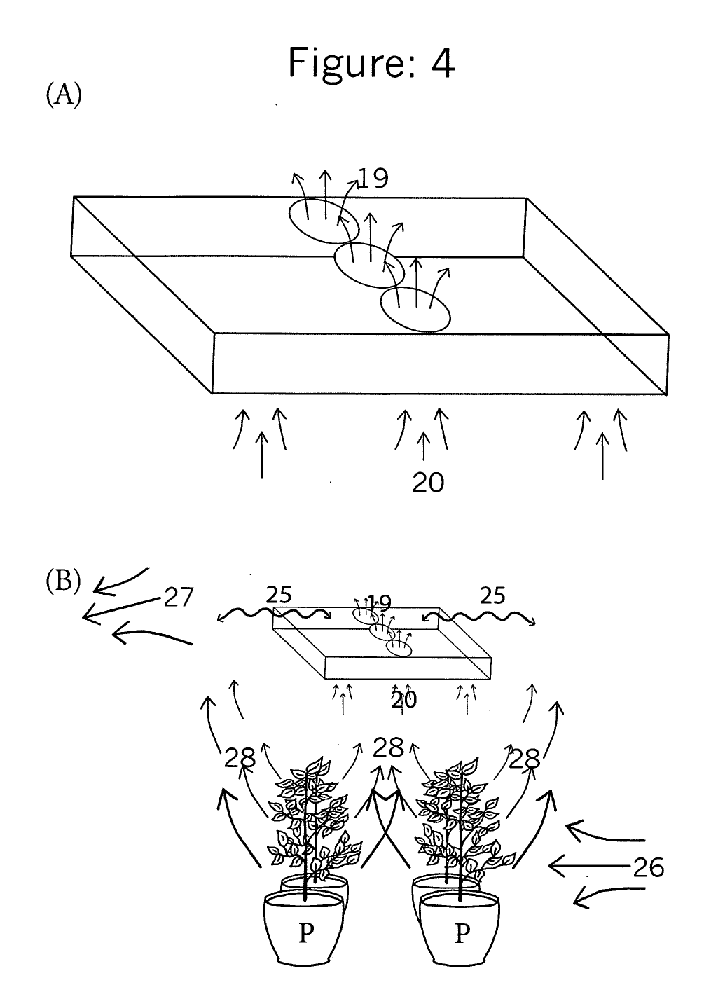

If and when made available technologically or affordably, modifications to the invention will be made. When a multifunctional control panel is programmed, it will be implemented to control light cycles, stage settings, and regulating the fans. If and when a technology surpasses the energy flux and wavelength of one or more emitters, it will be implemented. When available, small variations or additions within the bounds of (350-475 nm) and (635-800 nm) could specialize the light spectrum. If and when technology arises that can create circulation more effectively than that of a turbine or fan, it will be implemented. A liquid heat sink could be implemented to better displace heat from higher flux emitters. If and when any other radiant electro magnetic energy (such as hertz, reverberations, vibrations) are proven to affect the development of plants through morphological or biomass stimulation, then it too may be embodied as innovations. Removable power supplies and emitter clusters can be utilized to reduce refurbishing time and resources. If and when necessary, this lamp can be used in a shelter, which may accrue in space, under water, underground, in a cavern, on the canopy or any other space in the time continuum to promote horticulture and boost oxygen levels where sunlight may not be readily available (see FIG. 4 B).

When growing several plants, raise the lamp to the height that will accommodate the majority of the foliage while maintaining proximity. As the plants grow, raise the lamp gradually as needed. An effective way of keeping up with growth is to have chains that the lamp would latch to rise of the lamp automatically.

When growing a single plant, keep the height of the lamp close to the plant. This will increase illumination and maximize the amount of foliage that can receive photons. Whenever possible keep the lamp as close to the plants tops as possible. If height is an issue an alternative is to create bonsai style plants. (see FIG. 2)

What is claimed:

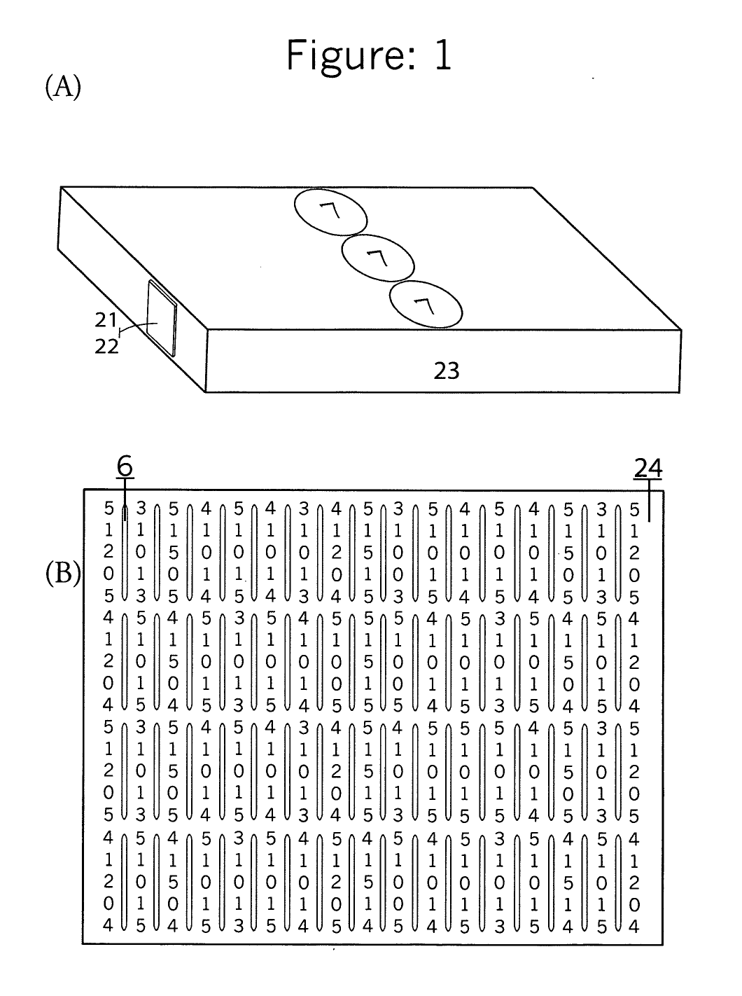

1. An electro magnetic apparatus that promotes growth through distinct photoperiodism stages of growth.
(A) State I: The purpose of this state is to promote plant establishment. A blend 630-820 nm and 350-475 nm bands will be present, a balance within 35% red and 65% blue are suitable. Metabolic stage will boost the blue color ratio of the lamp to promote foliage development and metabolic stimulation.
(B) State II: The purpose of this state is to establish the height and induce the plants reproduction. This state consists of 630-820 nm and 350-475 nm wavelengths band, a balances within 65% red to 35% blue are suitable. Floral stage will boost the red color ratio of the lamp to promote floral, seeding, fruiting, and height development. In most instances will induce reproduction in seasonal green plants.
(C) Interchangeable bands lie within:
Red spectrum: Dark Amber 635˜655 nm, Red 660˜670 nm, Deep Red 720˜740 nm, near infrared 770˜820 nm
Blue spectrum: Violet 350˜420 nm, Indigo 420˜435 nm, Blue 455˜475 nm. (FIG. 1B)
(D) The Lamp of claim 1 may have a switch to choose from several photoperiodism stages. When fit, single state lamps may be configured to supplement the lower portions of the plant or to accommodate photoperiodism specific cultures.
(E) A timer maybe implemented to the lamp so that photoperiodism (desirable light cycles) can easily be achieved and controlled.

2. The parts of the apparatus from claim 1 has been selected for their ability to aid plant's development and their efficiency in converting electrical energy to a portentous atmosphere.
(A) For every cc of air forced in via fan or turbine, there will be a means to remove that cc, therefore creating air circulation in the vicinity of the lamp supporting respiration, transpiration of the near by plants, along with regulating the inner components of the lamp.
(B) Shell will have brackets for mounting and detachable power cord for ease of handling. Components maybe metallic, ceramic, or composite; shells' compartment will contain the sensitive electronic components.
(C) These high flux-emitters have been chosen at various magnetic renascence and voltage consumptions for their ability to propagate photosynthesis, chlorophyll A-B and other desirable plant processes.
(D) The emitters are mounted on the bottom side of a reflective heat sink plate. Thermal grease ought to be incorporated to improve the thermal flux. See FIG. 1B
(E) Arrangements of the emitters in series may vary to suit their thermal-flux, voltage capacity, color ratio emitted, or size.
(F) Ideal for 4 to 20 plants depending on the reach of the foliage and photon-flux of the lamp at hand. See FIG. 2

3. Intended applications of the apparatus:
(A) Greenhouses, commercial hothouses, hydroponics, science labs, scion propagation, farming, educational observation, reviving sickly plants and other horticulture needs.
(B) If and when necessary, this lamp can be used in a shelter, which may accrue in space, underground, in a cavern, under water, in the canopy or any other spaces in the time continuum to promote horticulture and boost oxygen production.
